(19) United States
(12) Patent Application Publication
(10) Pub. No.: US 2013/0185317 A1
(43) Pub. Date: Jul. 18, 2013

(54) PDF ADDRESS EXTRACTOR FOR MAIL

(71) Applicants: Nathan J. Welton, Lafayette, IN (US); Jerry E. Staddon, Battle Ground, IN (US)

(72) Inventors: Nathan J. Welton, Lafayette, IN (US); Jerry E. Staddon, Battle Ground, IN (US)

(21) Appl. No.: 13/352,420

(22) Filed: Jan. 18, 2012

(51) Int. Cl. G06F 17/30

(52) U.S. Cl. 707/755; 707/E17.008

(57) ABSTRACT

A computer system for extracting address information from PDF documents to create a database of address information that can be used to generate address sheets for mail. It is preferred that the mail be accountable mail requiring feedback on the mailing process.

### BACKGROUND OF THE INVENTION

The present invention generally relates to the location and extraction of text from unstructured data files and the subsequent automatic generation of paper copies. In particular, the invention involves extracting text from Portable Document Format (PDF) documents, parsing the text into fields, and storing the resulting fields in a database. The invention also involves automatically generating paper copies of documents from the accumulated data which are then mailed.

Most mail is delivered without any delivery restrictions and is simply left in the recipient's mail box for pickup hours or days later. However, senders can, and commonly do, apply additional delivery restrictions at their discretion. For example, a sender can simply require confirmation of delivery by the recipient. Senders can also specify more complex requirements on the recipient like requiring the recipient to be a particular person, or that the recipient not be a minor, or that payment be collected. In all these examples, an accounting of the delivery is made possible by the collection of the recipient's signature making these all forms of “accountable mail.” Accountable mail is any type of mail that requires proof of mailing, or proof of delivery, or a recipient signature and/or payment of a fee from the recipient or the recipient's agent before delivery can be completed. Examples offered by the United States Postal Service®(USPS) include, but are not limited to, Registered Mail™, Certified Mail®, Signature Confirmation™, and collect on delivery (COD) mailing services. Accountable mail also includes mail requiring a signature that is processed by other carriers such as FedEx®, UPS®, and DHL®.

When using accountable mail, an address sheet or the like is prepared for documenting a signature and/or fee and/or proof of mailing and/or proof of delivery and/or proof of receipt. Preferably the address sheet at least incorporates some type of proof of receipt. The address sheet is also usually associated with some type of sticker, preprinted envelope, or mail sleeve having a unique identifier. The unique identifier usually appears as a number or bar code and is commonly used both for accounting purposes to properly manage collection of the increased handling charges associated with accountable mail, and also for facilitating later retrieval of the recipient's signature, or a copy thereof, as proof the mail piece was actually received, by whom, and when. Sending mail in this fashion requires the sender to address the mail piece itself, then apply the same address information to the accountable mail address sheet as well. Furthermore, the unique identifier, along with any other identifying information the sender would like on the address sheet must be transferred or recreated on the address sheet a second time as well.

Copying the address and unique identifier to both the mail piece and the address sheet by hand is not burdensome for a small number of mail pieces. However, creating hundreds or thousands of address sheets in this manner quickly overwhelms the resources available to a typical office staff and increases the opportunity for fatigue induced clerical errors. These manual steps have been largely eliminated by various vendors selling software, products, and services that automatically generate the mailed documents and the accountable mail address sheets. These systems generate pre-addressed, personalized documents along with the corresponding address sheets having the necessary identification numbers. In many cases, these providers offer accountable mail envelopes of the proper size, and shape having the correct identification markings to facilitate accountable mail delivery as well. The process is very fast and simple to execute because the address sheet, the mail piece, and in some cases the envelope itself, are all generated by software with access to the same store of address data.

However, if the documents to be mailed are generated by a separate entity with a separate data store which is not available to the sender creating the address sheets, the efficiencies of bulk automatic address sheet generation are lost and the accountable mail address sheets must be created by manual processing. This occurs, for example, in cases where a third party system generates a large number of PDF documents that are to be printed and mailed using accountable mail, each to a different recipient. The accountable mail address sheets cannot be automatically filled out using an automated system because the address information for each mail piece is embedded in each PDF document and the original address data is in a database that is now unavailable. Furthermore, a PDF document is an unstructured document meaning that it does not retain any information indicating types of elements on a given page. Therefore there is no way to “tag” or logically group elements during the PDF document generation process to indicate which part of the document is a street address, city, state, or zip code. In some instances, the PDF document may not even contain searchable text.

Therefore creating the address sheets using the address information in the PDF document requires a human to perform some type of manual process. The PDF must be either printed or displayed, and the address transferred to the address sheet either by hand writing it, or by typing it on a keyboard. The address fields can also be copied from one application window displaying the PDF document to another application window containing address data entry software by either typing it on a keyboard or by high-lighting each part of the address, ensuring the high-lighted area has been converted to text and converting it to text if necessary, copying the high-lighted text to the clipboard, then pasting the text into the appropriate field in the data entry window, and repeating these steps for each field of every address for every PDF document. All of these methods are time consuming and involve the risk of clerical errors, a risk that increases with the fatigue that is inherent in manually transferring a large quantity of data by manual means in a short period of time. It is, however, unavoidable in situations where accountable mail address sheets are generated in large quantities by organizations that do not have access to the address data that was used to create the documents being mailed.

What is needed then is a software application that extracts address information from a group of PDF documents and builds a database of address data that can then be used to generate accountable mail address sheets. Ideally this software would not require any interaction with the database used to create the original PDF documents, and it would also allow the operators to pass the captured data through an address validation service to both validate it and reformat it according to USPS standards.

### SUMMARY OF THE INVENTION

The current invention addresses the concerns mentioned above as well as others by providing a software system that facilitates the automatic generation of address sheets for accountable mail by creating a database of address data extracted from a collection of individual PDF documents. The software allows the user to specify a collection of PDF documents and to indicate the region within each document where the address is located by drawing a box around the address on one of the documents. The software also allows the user to specify the location of another piece of document identification information by a similar procedure. The software then extracts the address and document identification information from the respective regions of every PDF document in the specified collection automatically without any manual intervention. The text from each location is extracted and parsed into separate fields (e.g. street address, city, state, document identification, etc.) and stored in a database. The invention also provides for validation of the address data and handles various validation outcomes depending on the validation results including user notification with alternatives. The resulting address information is also reformatted according to USPS standards to facilitate faster delivery. Having built a database of address information extracted directly from the set of documents to be mailed, the present invention provides for the generation of an address sheet for accountable mail that corresponds to each of the original PDF documents.

Various forms, objects, features, additional aspects, advantages, and embodiments of the present invention will become apparent to those of ordinary skill in the art from the following detailed description when read in light of the accompanying drawings.

### BRIEF DESCRIPTION OF THE DRAWINGS

FIG. 1 illustrates the relationship between the component parts of the preferred embodiment of the present invention.

FIG. 2 is a flow chart describing the steps necessary to extract and validate the address information and produce address sheets for accountable mail.

FIG. 3 is an illustration of the graphical interface showing a PDF document rendered in an application window and the user selecting an address capture region on the rendered document.

FIG. 4 is an illustration of the graphical interface showing a PDF document rendered in an application window and the user selecting a document identification capture region on the rendered document.

FIG. 5 is an illustration of the graphical interface showing various address validation alternatives that might be available to the user for a single address.

FIG. 6 is an illustration of the graphical interface presented to a user after address validation has been performed on all the extracted address data in bulk.

### DETAILED DESCRIPTION OF THE PREFERRED EMBODIMENTS

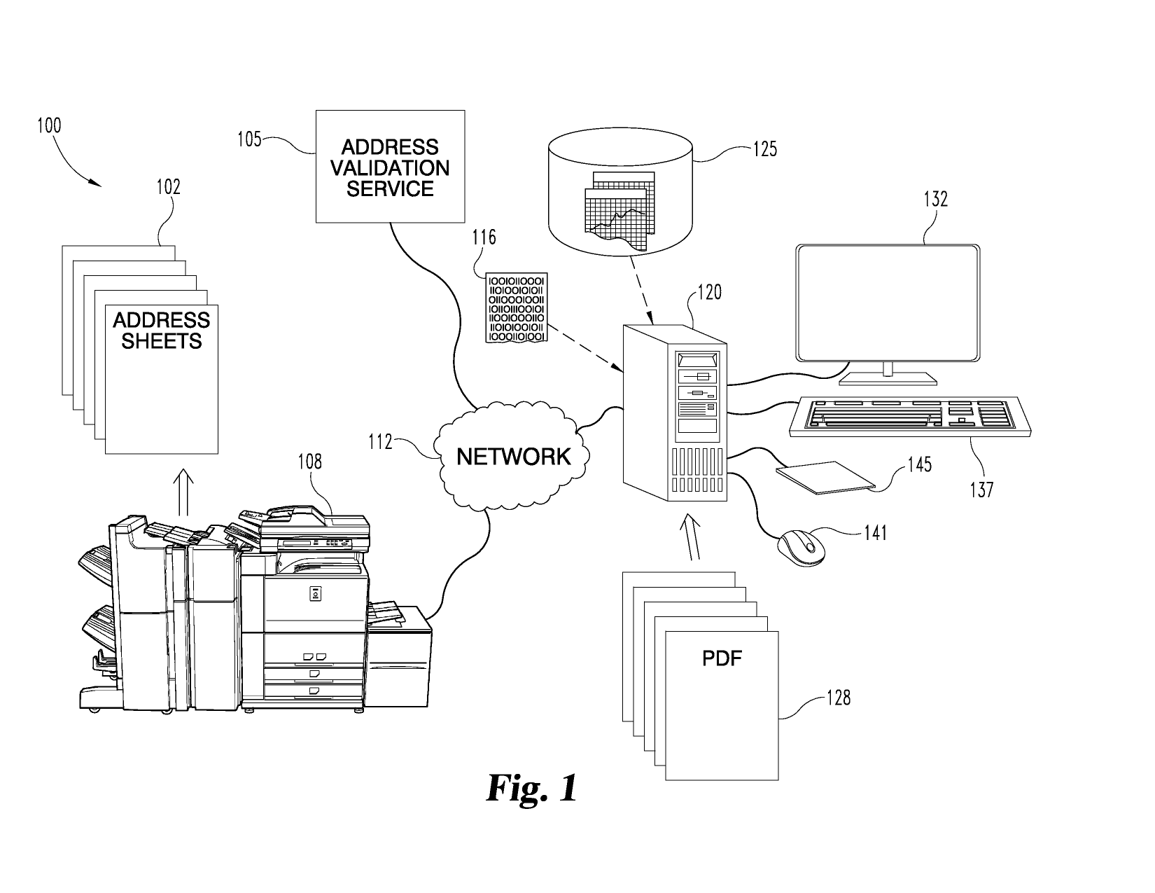

Referring first to the key components of the system as shown in FIG. 1, the preferred embodiment of a computer system for processing PDF documents appears at 100. It is composed of a software application 116 for processing a set of PDF documents 128 executing on computer 120, a printer 108 for generating documents, and an address validation service 105 optionally available for validating address data. A network 112 couples printer 108, computer 120, and address validation service 105 to facilitate the necessary data transfers. Address sheets 102 are preferably generated first as electronic files by computer 120 and then as printed documents by printer 108 for mailing.

Computer 120 manages the interactions between various parts of the system and is central to the processing of documents and management of data. Computer 120 is a general purpose computer that can load and execute software programs, process data, and communicate with other computers over network 112. Computer 120 can also run PDF document viewing software, database management software, spreadsheet software, and other types of document editing software commonly used in the preparation and distribution of mailed documents. It is understood by a person of ordinary skill in the art that general purpose computers such as computer 120 come in numerous shapes and sizes and therefore its appearance in FIG. 1 is illustrative only. Computer 120 could, for example, be a virtual machine operating on a very large server connected to network 112 along with numerous other virtual machines performing other unrelated tasks.

Computer 120 is coupled to various other devices such as monitor 132 which operates as a display device for displaying PDF documents that include address information. Monitor 132 may also be a touch screen monitor capable of sensing the location and movement of the user's fingers thereby allowing the user to interact with computer 120 and software running on it by touching portions of the screen designated to capture input from the user. In this way monitor 132 acts as a pointing device along with a mouse 141, and a touchpad 145 which are also coupled to computer 120. Computer 120 is also coupled to a keyboard 137 which can also function as a pointing device.

Software application 116 executes on computer 120 and extracts address information from PDF documents 128 and parses that information into separate fields. Database 125 stores these extracted and parsed fields. The application can also extract document identification information from each PDF document 128 and store it in database 125 as well. FIG. 1 illustrates the relationship between database 125, computer 120, and software application 116 and no assumptions about the type of database technology used should be made from FIG. 1. In the preferred embodiment, database 125 is a simple spreadsheet stored locally on computer 120. However, other embodiments of database 125 are possible and could be equally effective depending on the circumstances. Database 125 could be a simple delimited text file, or it could be embodied in one or more tables managed by a relational database management system (RDBMS) operating on computer 120 itself. In another embodiment, database 125 stores the extracted and parsed data fields as one or more tables managed by a RDBMS operating on another server physically remote from computer 120 accessible via network 112.

Address validation service 105 is available to determine whether addresses extracted from PDF documents 128 are valid and also for standardizing the address format. Address validation is not required in order to extract address data and prepare address sheets for accountable mail. However, it is advantageous to use such services to increase the likelihood of a successful and timely delivery. Address validation service 105 operates by correlating extracted address data with a reference database of corresponding data maintained externally from system 100. In one embodiment, address validation service 105 operates as a real time online service available to validate individual addresses as they are extracted and parsed. In this embodiment, the reference data is maintained on remote servers. In another embodiment, a client installed on computer 120 automatically downloads the address validation reference data over network 112 to a cache located on computer 120 so that validation operations are executed locally on computer 120 thereby improving the real time performance of address validation service 105 without degrading the quality of the service. A third embodiment of address validation service 105 is a service that allows users to submit many addresses for validation in a single file and returns the address data along with meta data indicating the validation result for each address. This is important because software application 116 may optionally submit the address information for validation in real time as the addresses are extracted from each PDF document 128, or it may submit all of the addresses for validation at the same time once extraction and parsing are complete. Regardless of how address validation service 105 functions, the key component of address validation service 105 is the reference database of data that corresponds to the address data extracted from PDF documents 128. This reference data is captured, maintained, and organized external to system 100 by another system.

The system at 100 also includes printer 108 which is capable of generating printed copies of the address sheets for accountable mail created by software application 116. The preferred embodiment of printer 108 is capable of automatically printing on both sides of a piece of paper because it may be advantageous for the printed address sheets to have the extracted address information printed on one side, and the contents of the original PDF document 128 printed on the other. However, various other embodiments of printer 108 are possible including those which facilitate two-sided printing by other means.

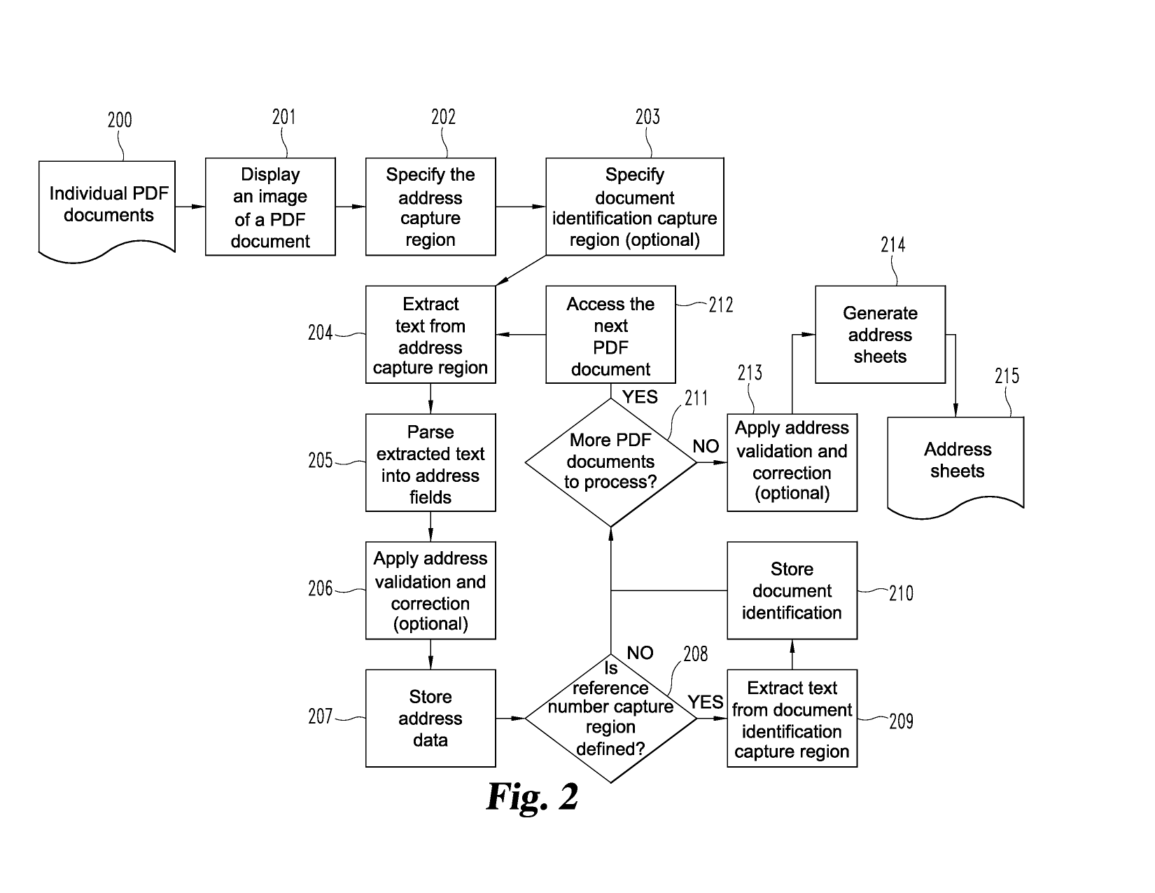

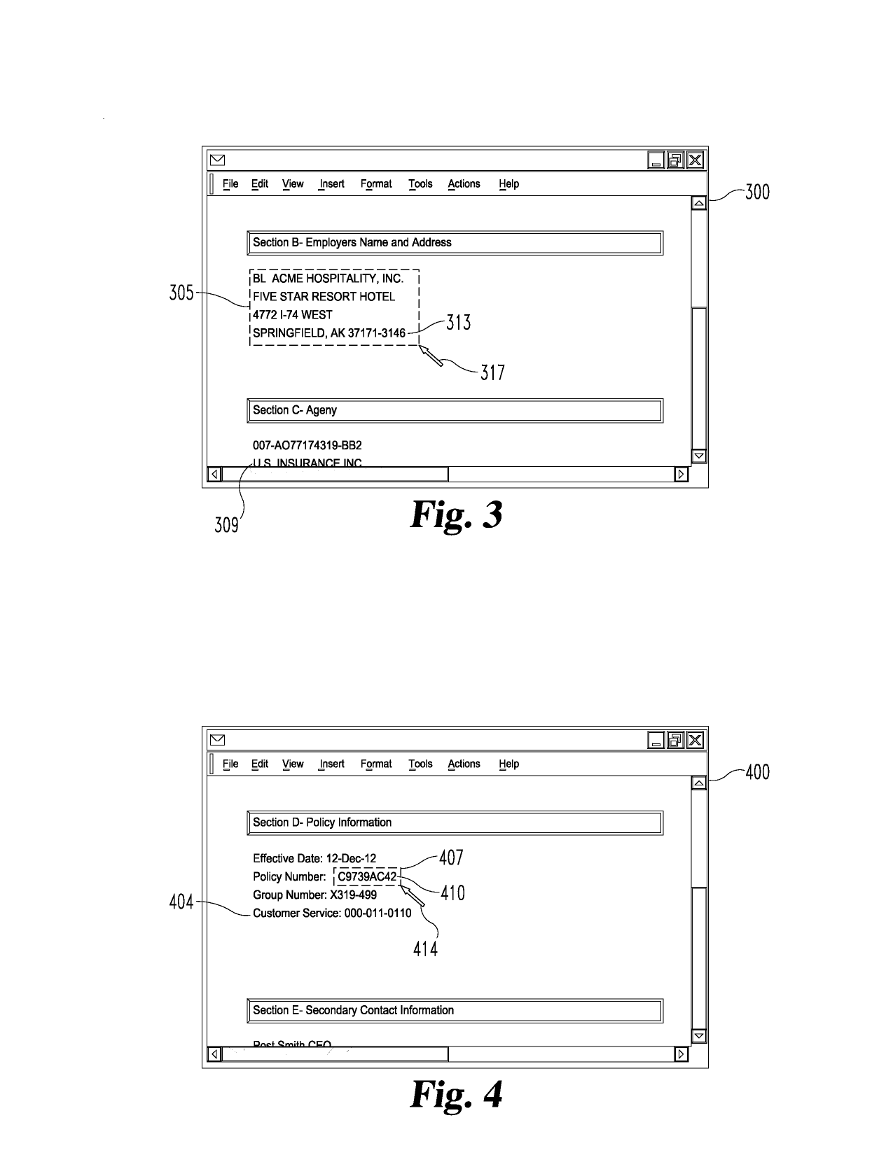

Having considered the major components of the system in FIG. 1, detailed consideration will now be given to software application 116 which operates according to the steps shown in FIG. 2. The set of PDF documents 128 previously mentioned which appear at the beginning in step 200 as inputs to the process. Software application 116 begins by displaying an image of an individual PDF document 128 on monitor 132 in step 201 and continues with the user specifying the address capture region in step 202. Steps 201 and 202 are illustrated in FIG. 3 which shows a PDF document 128 rendered by software application 116 in a viewing window 300 on monitor 132. Address information 313 appears along with other information 309 which is also part of PDF document 128 but is not part of address information 313. Capture region 305 is indicated by the common practice of moving screen pointer 317 by manipulating a device coupled to computer 120 to draw a box around address information 313 that includes all of the address information 313 but excludes all other information 309 that is not address information 313. The device coupled to computer 120 for moving the screen pointer and designating the box can be any of a wide variety of input/output pointing devices. Keyboard 137 can be used to designate the bounds of capture region 305 using keys. Mouse 141 may also be us by the commonly known practice of pointing, clicking, and dragging pointer 317. Touchpad 145 may also be used in a similar fashion to designate capture region 305 by touching, tapping, and dragging on the surface of touchpad 145. Likewise, touching and tapping the display surface of monitor 132 directly may be used to designate capture region 305 if monitor 132 is a touch screen monitor and computer 120 is configured to interact with it as a pointing device. Once capture region 305 is specified, the software will note the location of the region and extract the address information 313 from that location of every PDF document 128.

Software application 116 gives the user the opportunity to also specify a second capture region containing additional document identification information in step 203. Although not required, the document identification information is available to make future record keeping easier for the sender. A similar procedure is followed with regard to the document identification number capture region and is illustrated in FIG. 4. The same PDF document 128 displayed in window 300 appears in window 400 except a different area of it is now visible. The user manipulates one of the pointing devices coupled to computer 120 as described above to move pointer 414 to draw a box in window 400 to indicate a second capture region 407 around the document identification information 410 on PDF document 128 such that only document identification information 410 is enclosed inside it and all other information 404 is left outside.

Having determined where the address information and the document identification information are located on each PDF document 128, software application 116 now enters its main processing loop at step 204 of FIG. 2. In step 204, software application 116 extracts the text from the address capture region specified in step 202. In step 205, the software parses the extracted text into separate address fields depending the text provide preferably name, company name, apartment number or suite number, street address, city, state, and zip code. If other address fields are present, they are extracted and parsed as well.

If parsing succeeds, address validation and formatting optionally occur in real time for each address in step 206. Validating the address in step 206 allows software application 116 to determine immediately whether the address is valid or not and to allow the user to intervene. It may be advantageous for cost, performance, or other reasons to refrain from validating every address individually in real time during extraction and parsing. Waiting until all addresses are extracted and parsed before submitting them for address validation optionally occurs in step 213 as described below.

If validation is performed in real time in step 206, software application 116 automatically assembles extracted and parsed address data from individual PDF document 128, including at least the street address, and either the zip code or both the city and state. Other data that would correspond to the external reference database used by address validation service 105 may also be included such as first and last name. Upon assembling the necessary information, software application 116 automatically submits the address for validation and receives a response upon successful completion containing a correlating address (or addresses) and meta data indicating how closely the extracted and parsed address information correlated with the external reference database of corresponding address data maintained by address validation service 105.

Software application 116 will respond accordingly depending on the contents of the meta data. The address information taken from PDF document 128 will be replaced by the address information sent from the external reference database if the meta data indicates a very close correlation between the extracted address data and the address sent in the response. This is advantageous because the preferred embodiment of address validation service 105 corrects limited spelling and punctuation errors as well as more involved problems with the address such as obviously incorrect zip codes where this can be done without manual intervention. Thus using the validated and corrected address returned from address validation service 105 rather than the extracted and parsed data from PDF document 128 whenever possible ensures as much uniformity as possible in the resulting data with the fewest number of errors. Software application 116 will then automatically store the resulting validated and corrected address information into database 125 in step 207.

However, if the resulting meta data indicates the extracted address data does not correlate well with information in the external database of corresponding data used by address validation service 105, software application 116 makes available a range of options to the user at step 206. If the data does not correlate, or only part of the data correlates (e.g. street address exists but does not match the zip code), the software will automatically notify the user with the option to select a valid and corrected address from a list of alternatives from the address validation service 105 that correlate to the extracted address data submitted for validation. Upon selecting an alternative, the validated and corrected address data replaces the extracted data and is saved in database 125. However, the option to keep the address data as entered on the PDF document will also be available for those cases where the external reference database does not have the most recent or most accurate information, or for situations where the user wishes to override the validation results.

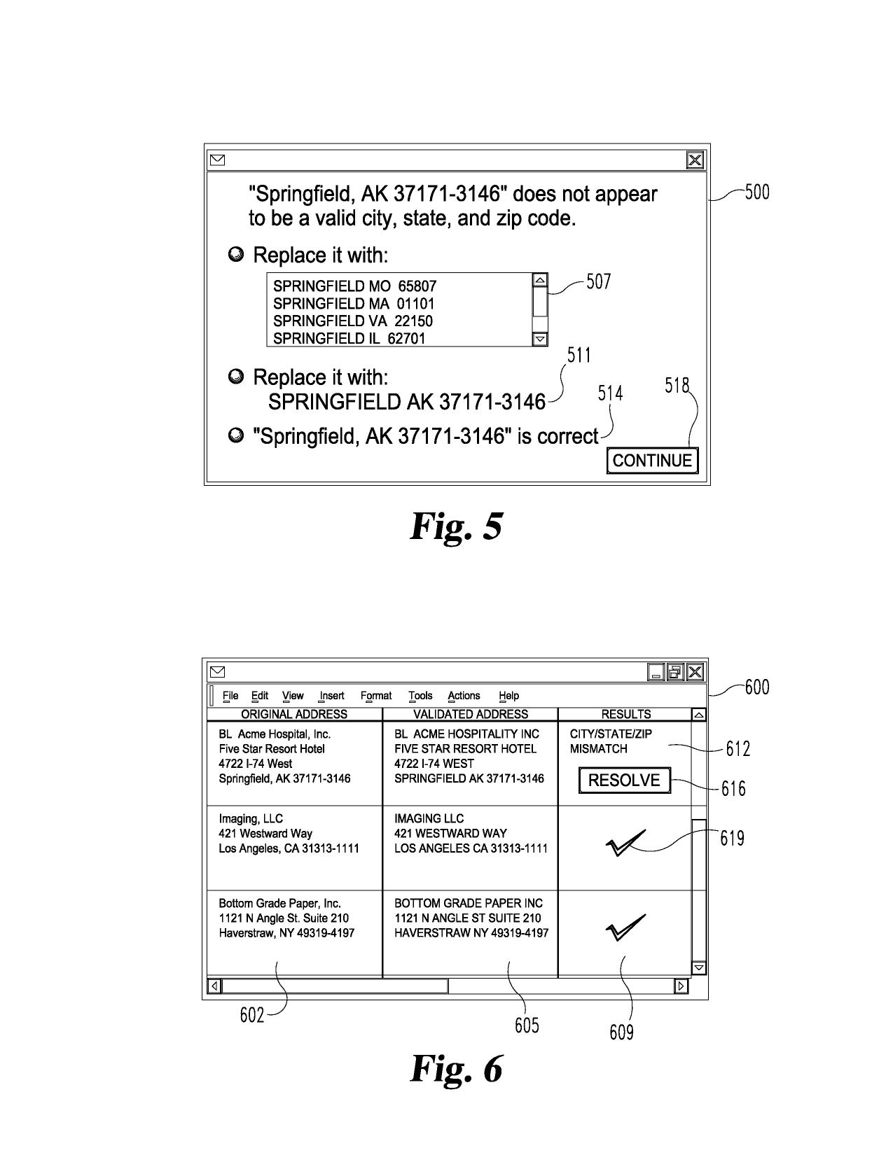

An example of this user interface appears in FIG. 5. The user interface appears in window 500 with the original address entered in the PDF document shown at 503. The user is presented with options 507, 511, and 514 for replacing or keeping the original address. The first option at 507 is a list of possible addresses the address validation service 105 is presenting as alternatives that might better correlate to the address extracted data. Selecting one of these results in the selected address data replacing the address data extracted from the PDF document 128. However, if the user wishes to keep the original address reformatted to meet USPS standards for format and punctuation, option 511 is available and choosing it replaces the originally extracted address information with the data as shown. Lastly, if the user wishes to keep the original address information unedited, option 514 is selected and the information maintained by software application 116 as is. Window 500 is preferably implemented as a modal dialog box meaning software application 116 would not continue processing until the user clicks the “continue” button 518.

Returning to FIG. 2, software application 116 executes step 208 to determine if the optional document identification capture region was defined in step 203. If so, software application 116 executes step 209 and extracts the text from the document identification capture region storing that text in database 125 in step 210 before proceeding to step 211. If no document identification capture region is specified in step 203, then the software application 116 skips directly from step 208 to step 211. In either case, step 211 marks the end of the PDF document processing loop for a given PDF document 128. In step 211, the software application 116 looks for more documents to process and if it finds any, it accesses the next document in step 212 and repeats steps 204 through steps 211 as detailed above. This processing loop preferably continues automatically until all PDF documents 128 have been processed. When all documents have been processed, step 211 will give a negative response ending the documenting processing loop.

After all PDF documents 128 are processed, software application 116 optionally performs address validation at step 213 if it was not performed during the extraction process at step 206. As with the real time validation in step 206, data including at least the street address, and either the zip code or both the city and state is pulled from database 125, marshaled, formatted, and sent to address validation service 105. In the preferred embodiment, this validation process happens as a separate process so that software application 116 does not need to wait for a response to continue. Software application 116 stops execution after step 213 and is restarted when the validation results are later received, preferably in the form of a file or set of files from address validation service 105 containing the results. However, other embodiments of software application 116 might find it advantageous to continue running but suspend operations on step 213 until address validation service 105 has completely validated all of the entries in database 125 and returned the results.

Regardless of how step 213 is executed, the response from address validation service 105 will preferably contain a new set of data with corrected and validated address data along with meta data indicating how closely the information in the external reference database of corresponding data correlated with the original address data extracted from PDF documents 128. Software application 116 processes the bulk validation results and presents the user with the same options provided in optional step 206. Extracted address information that closely correlates with data in the external reference database is automatically replaced in database 125. Address data that does not correlate closely is shown to the user with various options presented for how it should be stored.

FIG. 6 shows a user interface for how software application 116 would facilitate the process of reviewing the results of a bulk address validation performed in step 213. The results are displayed in window 600 with the original addresses appearing in a column 602, and the validated addresses appearing in another column 605. The meta data results are represented in a results column 609. Results column 609 displays various representations of the results such as a “success” icon 619 indicating a close correlation between the original address and the validated address. Where the correlation was not close, results column 609 shows a reason 612 for the mismatch and a button 616 giving the user options for resolving the discrepancy. Clicking button 616 causes software application 116 to open user interface window 500 with text and options similar to what is shown in FIG. 5 having specific options tailored to the particular scenario caused by the poor correlation between that particular address and the external reference data used by address validation service 105.

Having captured and validated the addresses and stored them in database 125, software application 116 now generates address sheets for accountable mail in step 214. Address sheets are generated first in electronic form by software application 116 directly, or possibly by another software application operating under the command of software application 116. After electronic copies are generated, hard copies are printed for mailing on printer 108. Printer 108 is capable of printing the original PDF document on one side of a page while printer the extracted and parsed address and document identification information on the other positioned according to the sender's requirements.

While the invention has been illustrated and described in detail in the drawings and foregoing description, the same is to be considered as illustrative and not restrictive in character, it being understood that only one embodiment has been shown and described and that all changes, equivalents, and modifications that come within the spirit of the inventions defined by the following claims are desired to be protected. Specifically, while the invention is set forth in the context of the preferred use with accountable mail, the scope of the invention is not to be so limited except for the claims that expressly recite accountable mail.

What is claimed is:

1. A computer system for processing PDF documents comprising:
A computer with a display device for displaying a PDF document that includes address information;
A device coupled to the computer for indicating a first capture region of the displayed PDF document containing address information and excluding other information outside the first capture region;
A software application for extracting the address information from within the first capture region, and for parsing the address information into at least three address fields; and
A database for storing the extracted and parsed address fields.

2. The system of claim 1 further comprising:
A device coupled to the computer for indicating a second capture region of the displayed PDF document containing document identification information and excluding other information outside the second capture region; and
A database for storing the document identification information.

3. The system of claim 1 further comprising a device for generating documents having the address information.

4. The system of claim 2 further comprising a device for generating documents having the address information and the document identification information.

5. The system of claim 3 or 4 where the generated documents are address sheets for accountable mail.

6. The system of claim 5 where the generated documents are address sheets requiring proof of delivery for accountable mail.

7. The system of claim 3 or 4 where the generated documents are address sheets having the extracted address information on one side and the PDF document on the other.

8. The system of claim 1 or 2 further comprising:
Software for automatically assembling extracted address data including street address, and either the zip code or both the city and state; and
Software for automatically determining whether the extracted address data correlates with information in an external reference database of corresponding data.

9. The system of claim 8 further comprising software for automatically notifying a user when the extracted address data does not correlate with information in the external reference database of corresponding data.

10. The system of claim 8 further comprising software for automatically replacing the address information extracted from the PDF document with address information from the external reference database of corresponding data that correlates to the extracted address data.

11. The system of claim 10 further comprising software for enabling a user to replace the address information extracted from the PDF document with address information from the external reference database of corresponding data that correlates to the extracted address data.

12. The system of claim 1 or 2 where the extracted and parsed address fields stored in the database are name, street address, and either zip code or both city and state.

13. The system of claim 12 where the extracted and parsed address fields stored in the database further include company name and either apartment or suite number.
